(19) United States
(12) Patent Application Publication
(10) Pub. No.: US 2024/0246089 A1
(43) Pub. Date: Jul. 25, 2024

(54) System and Method for Enhanced Separation and Recovery of Heavy Metals and Rare Earth Elements from Electronic Waste, Mining Residues, and Sediments Using Electronic Charge, Magnetic Beads, and Bubble Mechanisms

(71) Applicant: ROYAL BIOTECH INC, BEVERLY HILLS, CA (US)

(72) Inventors: Philip Huang, WESTLAKE VILLAGE, CA (US); E-Ray Huang, WESTLAKE VILLAGE, CA (US)

(21) Appl. No.: 18/587,225

(22) Filed: Feb. 26, 2024

Related U.S. Application Data
(63) Continuation-in-part of application No. 18/055,948, filed on Nov. 16, 2022, now abandoned.
(60) Provisional application No. 63/280,498, filed on Nov. 17, 2021.

(51) Int. Cl. B03B 5/32; B03B 5/04; B03B 13/00

(52) U.S. Cl. CPC B03B 5/32; B03B 5/04; B03B 13/005

(57) ABSTRACT

An advanced method and system for processing mixtures containing clay, metals, and pollutants. The process begins with the separation of clay and metal, followed by the detoxification of pollutants using magnetic beads. Enhancement of pollutant treatment is achieved through the application of nano-bubbles generated by a proprietary bubble generator. The method further includes a detailed screening and classification of particles, utilizing magnetic and gravity separation techniques, the latter of which is supported by an innovative anti-leakage net designed to capture and recycle leaked particles. The process concludes with the effective separation and collection of target elements and rare earth elements (REE), employing flotation for the final classification and extraction. This method represents a comprehensive and efficient approach to mixture processing, emphasizing pollutant removal and resource recovery.

### FIELD OF THE INVENTION

The present invention relates generally to the field of material processing. More specifically, the present invention relates to an innovative system and method designed for the classification, separation, and sorting of solid materials.

### BACKGROUND OF THE INVENTION

Sorting and separating solid materials is crucial for many industries, businesses, and individuals. A key focus is on environmentally friendly methods for sorting and extracting specific elements from mixtures. Traditionally, processes like flotation or leaching have been used for centuries to pull out target metals by breaking down materials to very fine sizes.

These methods work well for small particles and offer benefits over older gravity separation techniques. However, they fall short when dealing with very fine particles larger than 500 mesh.

Shaker tables are commonly used to sort a variety of materials, including minerals, sludge, and electronic waste, thanks to their high efficiency. But, their effectiveness is limited by factors such as the material's water solubility, density (if it's below 4.0), and the size of its particles, especially if they don't fall within the 20 to 500 mesh range.

Mining faces additional hurdles with the mixture of different metals and clay in materials, which makes it hard to separate and recover metal particles. Traditional chemical separation methods are widely used but can harm the environment. These methods also struggle with clay-rich materials, leading to lower recovery rates and affecting profits. This is a growing concern as the world focuses more on environmental protection and sustainability.

The scattered distribution of rare earth elements (REEs) in the earth's crust makes it hard to exploit them commercially. The environmental and health risks from processing REEs, due to their high toxicity, pose significant challenges in separating these elements.

The existence of over 30,000 tailings ponds, with more than 3,000 being a direct danger, raises serious environmental and health concerns. The risk of these tailings contaminating water and entering the food chain is a significant threat to communities. With the mining industry expected to produce an additional 40 to 50 billion tons of tailings in the next five years, improving current separation methods becomes crucial. Traditional methods often fail to fully recover metals, leaving behind large amounts of fine or low-density metal residues that are hard to recycle.

Additionally, the growing amount of electronic waste, which contains valuable metals and rare earth elements, presents a significant opportunity for resource recovery. Even though individual devices contain only small amounts of precious metals, the total amount of resources in electronic waste is considerable. Tackling the challenges of recycling tailings and electronic waste not only supports industrial growth by providing raw materials but also reduces environmental damage by lessening the need for new mining operations.

Therefore, there is a need for improved methods, systems, apparatuses, and devices for facilitating green screening, classification, and adsorption of target elements from a mixture that may overcome one or more of the above-mentioned problems and/or limitations.

### BRIEF DESCRIPTION OF THE DRAWINGS

FIG. 1 is an illustration showing one embodiment of the present invention connected to a flotation column.

FIG. 2 is an illustration showing one embodiment of the bubble generator of the present invention.

FIG. 3 is an illustration showing an alternative embodiment of the bubble generator of the present invention.

FIG. 4 is an illustration showing one embodiment of the present invention, 3 in one Bubble Flotation System.

FIG. 5 is flowchart of one embodiment of the present invention method.

FIG. 6 is flowchart of a subprocess of the present invention method.

FIG. 7 is flowchart of a subprocess of the present invention method.

FIG. 8 is flowchart of a subprocess of the present invention method.

FIG. 9 is flowchart of a subprocess of the present invention method.

FIG. 10 is flowchart of a subprocess of the present invention method.

FIG. 11 is flowchart of a subprocess of the present invention method.

FIG. 12 is flowchart of a subprocess of the present invention method.

FIG. 13 is flowchart of a subprocess of the present invention method.

FIG. 14 is flowchart of a subprocess of the present invention method.

FIG. 15 is flowchart of a subprocess of the present invention method.

FIG. 16 is flowchart depicting the steps involved in treating pollutants or toxins according to one embodiment of the present invention method.

### DETAIL DESCRIPTIONS OF THE INVENTION

All illustrations of the drawings are for the purpose of describing selected versions of the present invention and are not intended to limit the scope of the present invention.

The present invention introduces a revolutionary system and method for the classification, separation, and assortment of solid materials. It overcomes the limitations of traditional processing methods by employing a novel combination of mechanical, chemical, and physical processes tailored to efficiently handle ultra-fine particles and complex material compositions. The system is designed to be adaptable to various material properties, enabling the effective recovery of valuable metals, including rare earth elements, from a wide range of sources such as mined ores, tailings, and electronic waste.

Key innovations include a proprietary separation mechanism that significantly reduces the impact of clay and other contaminants, an advanced filtration technology that captures ultra-fine particles, and a green chemistry approach that minimizes environmental harm. The system also incorporates machine learning algorithms to optimize processing parameters in real-time, ensuring maximum efficiency and recovery rates.

The present invention includes a unique device, “Bubble Generator.” The device is an innovative device designed to enhance the efficiency and environmental sustainability of flotation processes used in mineral processing and other applications. Unlike traditional flotation machines or devices that generate only one type of large bubble, this device can produce three different types of bubbles: traditional bubbles, microbubbles, and nanobubbles. These bubbles vary in size, with nanobubbles being less than 1 nm in diameter and microbubbles ranging from 1 um to 1 mm. This capability allows for the simultaneous or sequential generation of bubbles of different sizes, tailored to specific needs.

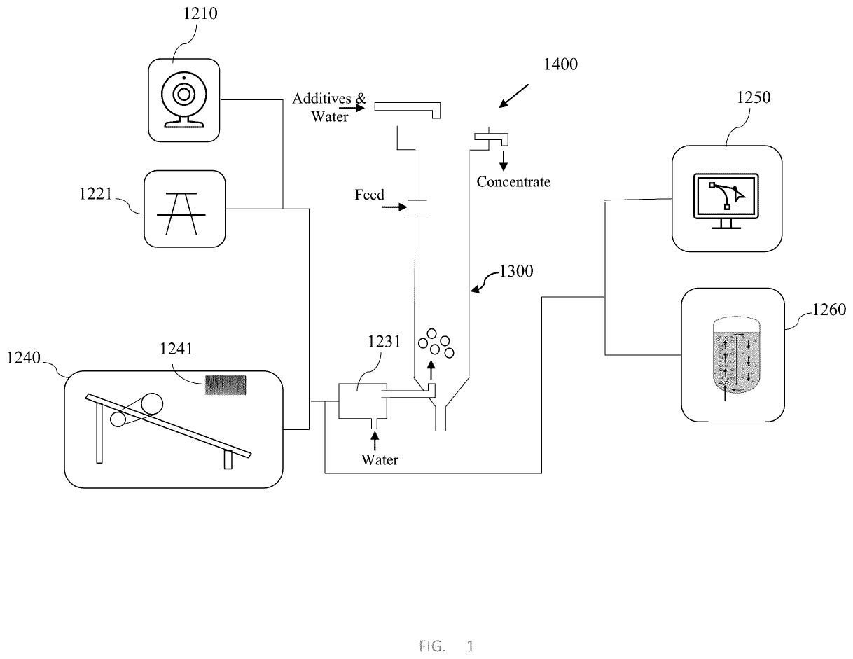

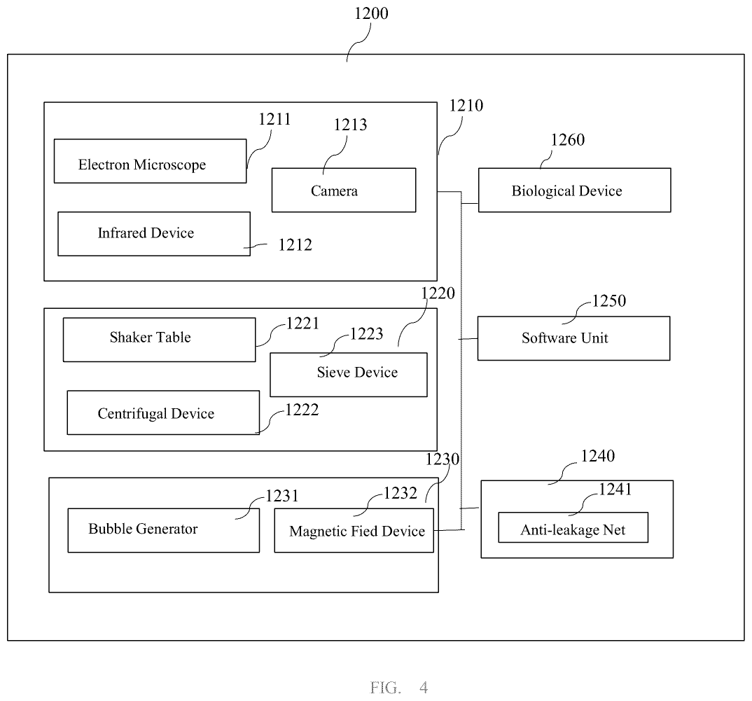

As shown in FIG. 1 and FIG. 4, the present invention provides a system (3 in-one Bubble Flotation System) 1200 comprising a software unit 1250; a photographic observation system 1210; and a bubble generator 1231. Each of the software unit 1250, the photographic observation system 1210, and the bubble generator 1231 are interconnected with one another.

In one embodiment, the photographic observation system 1210 may further comprise an electron microscope, a camera, and an infrared device.

In one embodiment, the system 1200 of the present invention may further include a floatation device 1230 that may comprise the bubble generator 1231 together with a magnetic field device 1232; and the system 1200 of the present invention may further include a grinding system 1240 that may comprise an anti-leakage net 1241.

In another embodiment, the system 1200 of the present invention may further include a gravitational device 1220 that can include a shaker table, a sieve device, and a centrifugal device.

In some embodiment, the system 1200 may further comprise a grinding system 1240; a magnetic field device 1232, and a biological device 1260, wherein all the components, the grinding system 1240 includes an anti-leakage net, wherein each of the software unit 1250, the photographic observation system 1210, the bubble generator 1231, the gravitational device 1220, the grinding system 1240, the magnetic field device 1232, and the biological device 1260, are interconnected with one another.

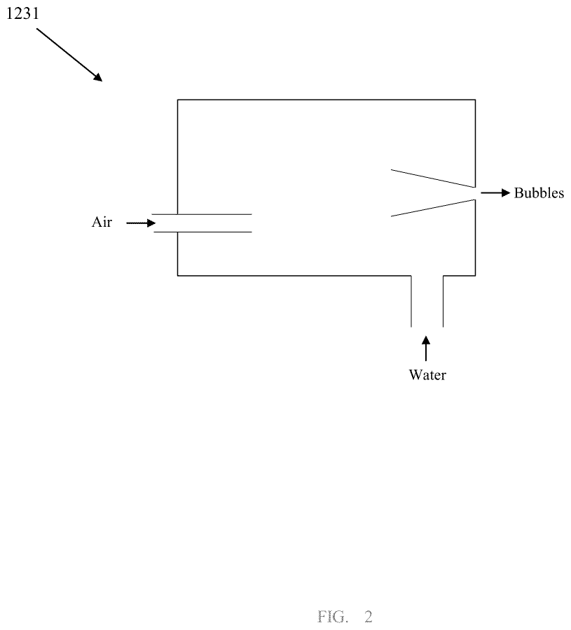

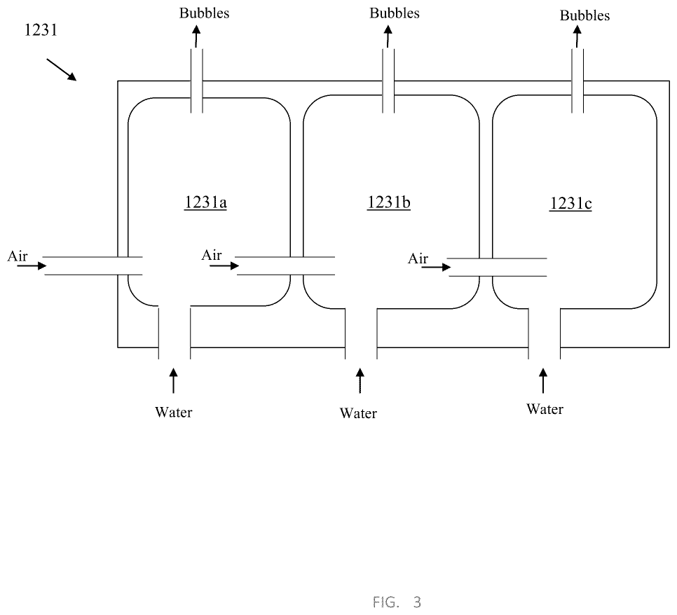

The system 1200 of the present invention may generate bubbles of varying sizes (traditional, micro, and nanobubbles) according to the needs of the flotation process. This is achieved through a sophisticated mechanism that allows for the simultaneous or sequential production of different bubble types. As shown in FIG. 2, the bubble generator may include an internal structure suitable structure to generate different types of bubbles when air and water flow are provided. In some embodiments, as shown in FIG. 3, the bubble generator 1231 can be manufactured by combining three types of bubble generators (Traditional Bubble generator 1231a, Micro-Bubble generator 1231b, Nano-Bubbles generator 1231c) into one.

The bubble generator 1231 can be connected to a photographic observation system 1210, including an electron microscope and infrared/Near Infrared (NIR) cameras, along with a software unit 1250. The software unit 1250 can be any software known in the art and configured to analyze collected data using software algorithms to automatically or semi-automatically adjust bubble emission sequence and size to optimize the flotation process of the present invention.

In some embodiments the software unit 1250 can be connected to a computing device wherein the computing device may further include various types of photographic chips to collect flotation & recycling live data, then conduct data analysis to control various environmental factors, bubble size, quantity, order, etc. and achieve optimal recovery rates. The computing device may include but is not limited to the personal computer, laptop, desktop computer, tablet, personal digital assistant, server, mobile phone and the like, wherein the present invention can be realized either by operating the terminal device and/or computing device separated or by the interactive operation between the terminal device and/or computing device after accessing network and other computers in the network, wherein the network of the terminal device/computing device includes but not limited to network, mobile communication network, WAN, MAN, LAN and VPN and the like. The devices in the network include but not limited to a single network server, a network server group consisting of a plurality of network servers, or the cloud consisting of a number of computers or network servers on the basis of cloud computing, wherein the cloud computing, as one distributed computing, is a super virtual computer consisting of a group of loosely-coupled computer set.

It should be noted that the terminal device, computing device, network device and network are only examples. Other present or future possible computing device or network, if applicable, should also be included under the protection scope of the present invention and cited herein as reference.

The present invention, “3-in-One Bubble Flotation System,” not only facilitates bubble generation but also seamlessly integrates with an advanced photographic observation system 1210 and a software unit 1250. This integration serves as the foundation for the system's ability to efficiently process and analyze data concerning mixtures undergoing flotation treatment.

The bubble generator 1231, a pivotal component of the present invention, 3-in-One Bubble Flotation System, is designed to facilitate the generation of bubbles that can be precisely controlled in terms of size, buoyancy, and emission sequence. Such control is critical for optimizing the flotation process, particularly in the recovery of target elements and rare earth elements.

In one embodiment, to enhance the system's operational efficiency, an array of sensors and monitoring devices can be employed. These devices can be strategically positioned in the flotation system including the flotation column 1300 to capture real-time data concerning the mixture's characteristics and the environmental conditions within the flotation system 1400. The acquired data is then transmitted to the software unit 1250, which, powered by advanced electronic chips, performs a comprehensive analysis. This analysis may enable the identification of optimal operational parameters, thereby ensuring the flotation process is finely tuned to achieve maximum recovery rates.

The 3-in-One Bubble Flotation System may dynamically adjust the buoyancy of the bubbles. This adjustment is crucial for manipulating the recovery rate of the flotation process, as different target elements may require bubbles of varying buoyancy for effective separation. Additionally, the system's capability to modify bubble size and emission order in real-time allows for unparalleled precision in matching the flotation characteristics of specific target particles. This precision ensures that the separation process is highly selective, significantly reducing the loss of valuable materials.

In some embodiments, the bubble generator 1231 connected to the software unit 1250 and photographic observation system 1210 can be configured to perform three operational steps: suctioning, mixing, and feeding, ensuring a thorough and efficient flotation process. This innovative equipment stands out from conventional bubble generators by its ability to produce three levels of bubbles and its enhanced adaptability to the varying particle sizes of mine tailings, WEEE, sludge, and pollutants. The buoyancy of the bubbles, which is a critical factor in the recovery efficiency, can be finely tuned to the specific needs of the material being processed, making the present invention a significant advancement in flotation technology.

For the separation of particularly fine particles, advanced techniques involving “USB-Ultra-Fine Bubble” or “Micro-Bubble” can be employed to enhance the efficiency of floating screening processes. In gravity separation processes, each outlet of the shaker is equipped with filters and centrifugal facilities to concentrate and further separate the output from each outlet. This setup is designed to differentiate between mud and target metal particles based on their density or size, facilitating the screening of target metals. There are two primary scenarios for separation: If the particles of mud and target metal are of the same size, screen-based separation becomes challenging. However, high-speed centrifugation can achieve separation by leveraging differences in density or weight, causing materials with lower density or weight to float or remain on top, while those with higher density or weight settle down. Typically, the density of clay ranges from 2.7 to 2.75, and the density of sand ranges from 1.3 to 2.65. If the density or weight of the materials is also similar, centrifugation becomes ineffective, and flotation might be considered as an alternative.

If the particle sizes differ, sieving can be used for separation. Following the use of flotation to discharge material, in addition to the previously mentioned methods (filters and centrifugal facilities), flotation stages may incorporate “Nano-Bubble (UFB-Ultra-Fine Bubble)” or “Micro-Bubble” in conjunction with a “Target Metal Adjuvant.” This approach deviates from traditional bubble usage and leverages the extremely small size of nano or micro-bubbles to adsorb ultra-fine target particles. This method addresses the challenge of recovering fine particles that are difficult to separate due to their small size. Nano-bubbles are defined as having a diameter of less than 1 μm, while micro-bubbles have a diameter ranging from 1 μm to 1 mm. This advanced flotation technique significantly enhances the separation and recovery of fine particles, offering a more efficient solution for processing materials with challenging characteristics.

The software unit 1250 may act as the central hub for managing the flow of incoming material through various stages of the present invention. It may be configured to process and operate the hardware involved, such as centrifugal devices 1222, to ensure efficient screening and separation of materials.

The software unit 1250 can be configured to perform a multitude of operations, including but not limited to, the presentation of a gravity-based subprocess in conjunction with a flotation subprocess. It possesses the capability to elect the gravity subprocess predicated upon an analysis of a conglomerate of gravitating masses. This entails a comprehensive examination of parameters such as particle size, quantity, and type. Additionally, the software unit 1250 is adept at determining the optimal bubble size and sequence for the process.

In some embodiments, the software unit 1250 can be specifically designed to invoke the selection of the flotation subprocess under conditions where the mass of a designated target particle is equivalent to that of a particle deemed as waste. In such embodiments, the software unit 1250 can be further configured to select charged microorganisms as part of the process optimization.

Incorporated within the software unit 1250 can be AI (artificial intelligence) modules that leverage artificial intelligence or machine learning algorithms, enhancing its decision-making capabilities. Furthermore, the software unit 1250 can be equipped with the functionality to selectively identify and choose a particular microorganism, thereby optimizing the subprocesses for enhanced efficiency and effectiveness. This configuration demonstrates an innovative approach to material separation processes, leveraging advanced software capabilities to adaptively manage and optimize subprocesses within the system 1200.

The gravitational device 1220 can be a device that utilize the force of gravity to separate materials based on differences in mass or density. In some embodiments, the gravitational device 1220 can include machines designed to extract useful materials from a mixture of gravitating masses. The gravitational device 1220 can be a shaking table or other gravitational devices like jig concentrators, spiral concentrators, and hydrocyclones.

The photographic observation system 1210 can be a system that uses images captured on photographic emulsions to qualitatively and quantitatively analyze objects in the present invention. The photographic observation system 1210 is a crucial tool for monitoring and assessing the characteristics of materials being processed.

The flotation device 1230 is a device specifically designed for the separation of target heavy metals or mixtures by utilizing the principle of flotation. It aids in the screening out of desired materials from a mixture based on their buoyancy. In some embodiments, the flotation device can include a bubble generator 1231 and a magnetic field device 1232.

The magnetic field device 1232 can be a Magnetic Separator or Magnetic Separation Equipment. These devices are used to separate ferrous materials (materials that are magnetic or become magnetic when in the presence of a magnetic field) from non-ferrous materials in various processing applications, including flotation processes. The magnetic field device 1232 can include Drum Magnets, Overband Magnets, and High-Gradient Magnetic Separators (HGMS).

The flotation device 1230 mayalso include, but not limited to, Mechanical Flotation Cells, Column Flotation Cells, Jameson Cell, Induced Gas Flotation (IGF), Dissolved Air Flotation (DAF), and Electro-flotation.

The grinding system 1240 is a power tool or machine tool that uses an abrasive wheel for cutting, grinding is a machining process that achieves high surface quality and dimensional accuracy by removing small chips from the workpiece through shear deformation. All the roles involved in breaking down materials into smaller, more consistent sizes. It is essential to select or combine various methods based on the materials to reach the desired size. The effectiveness of the Grinding System depends on the technological expertise and the materials chosen for constructing the grinding system.

The grinding system 1240 includes, but not limited to, a Crusher, a Spiral machine, Ball Mills, Hammer Mills, Rod Mills, Jet Mills, SAG (Semi-Autogenous Grinding) Mills, Attrition Mills, Disc Mills.

The biological devices 1260 can be devices that involve the use of living materials or systems to measure and manipulate biological properties. Employing a range of technologies, biological devices can lead to new discoveries in bioscience applied to fields like mining or waste management. biological devices 1260 may include but not limited to Bioleaching Systems, Phytoremediation Plants, Bioreactors for Composting, Enzymatic Degradation Units, Microbial Fuel Cells, and Biosorption Systems.

The centrifugal device 1222 is a device that is configured to utilize the principle of centrifugal force to sort materials based on density differences. It's effective in separating mineral or solid waste into distinct streams for further processing.

The anti-leakage net 1241 is a device designed to prevent the unauthorized leakage of heavy metals or target elements during the screening process. It ensures the containment and safe handling of potentially hazardous materials.

The anti-leakage net can be a mesh composed of materials such as metal, plastic, cotton, and others and positioned beneath the grinding system to capture materials that are lost during the grinding process. This is due to the fact that many types of grinding equipment tend to have a significant loss rate while operating, which in turn lowers the recovery rate of the targeted element. Therefore, an anti-leakage net is implemented to gather any lost materials under the grinding system.

The anti-leakage net 1241 mayinclude but not limited to Vibratory Screens with Fine Mesh, Trommel Screens with Specialized Linings, Optical Sorters, Eddy Current Separators, Dust Collection Systems, Fluidized Bed Separators, High-Gradient Magnetic Separators (HGMS), and Microfiltration or Ultrafiltration Systems.

The sieve device 1223 is a device used for the detailed classification of incoming materials based on various attributes such as weight, specifications, shape, size, and color reaction. It enables the precise sorting of materials for further processing or disposal. The sieve device 1223 mayinclude a vibrating screen or vibratory sieve.

The present invention also provides a method 100 for screening, classification, and adsorption of target elements from a mixture containing rare earth elements (REE) and waste.

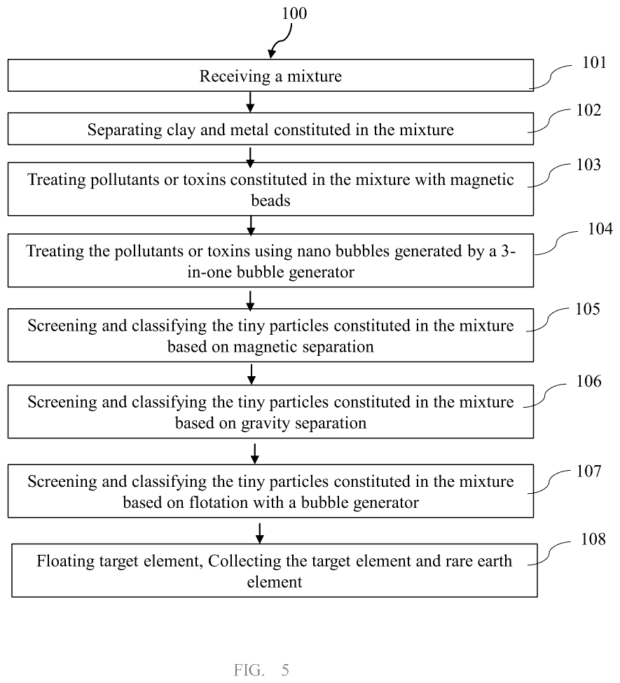

In one embodiment, as shown in FIG. 5, the method 100 may include several steps:
Receiving a Mixture (Step 101): The initial step involves receiving a mixture of elements, particles, rare earth elements, and waste.
Separation of Clay and Metal (Step 102): This step separates clay and metal components from the mixture. A mixture is a combination of elements and particles including both rare earth elements and waste.
Treatment of Pollutants with Magnetic Beads (Step 103): Pollutants or toxins in the mixture are treated using magnetic beads to remove elements that could corrode REE or harm individuals. The toxins are elements that are unwanted within the final product that could potentially corrode the rare earth element (REE) or harm an individual that comes in contact with the mixture still containing toxins.
Use of Nano Bubbles for Pollutant Treatment (Step 104): Pollutants are further treated with nano bubbles generated by a bubble generator, which helps in recovering materials within the mixture through a floating filtering method. This also involves the destruction of pollutants' structure to remove pollution. The UFB-Ultra-Fine Bubble explosion principle may be used to destroy the structure of pollutants (e.g. pesticides or chemical agent residues) contained in incoming materials to remove pollution.
Magnetic Separation for Screening and Classifying Particles (Step 105): Tiny particles in the mixture are screened and classified based on magnetic separation, utilizing high gradient fields for material recovery. The magnetic separation usually uses high gradient fields to recover different materials. The tiny particles have a low density or size that make screening difficult.
Gravity Separation for Screening and Classifying Particles (Step 106): This involves using gravity separation, including an anti-leakage net, to collect and redirect leakage into a feeding port for further processing. The gravity separation includes an anti-leakage net underneath the grinding system. The anti-leakage net avoids loss and collects and resets the leakage into a feeding port connected to the gravitational device.
Floatation for Screening and Classifying Particles (Step 107): This step uses flotation to screen and classify tiny particles in the mixture with bubble generator
Collection of Target Elements and REE (Step 108): The final step involves collecting the target elements and rare earth elements from the processed mixture.

The method 100 of the present invention aims to efficiently extract valuable materials from mixtures containing a variety of elements, including waste and rare earth elements, while addressing environmental concerns.

The method 100 may involve a series of sub-processes for filtering and recovering target particles from a mixture, utilizing various innovative techniques:

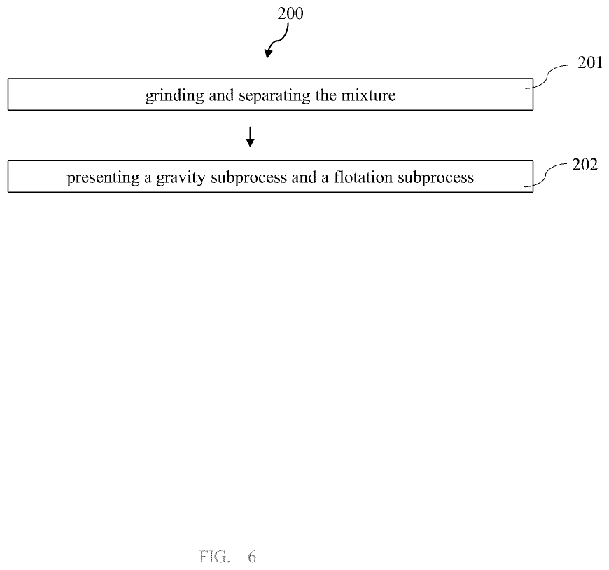

Grinding Before Filtration (Sub-process 200, FIG. 6): Involves grinding the mixture to make separation and filtration easier, followed by gravity and flotation subprocesses based on the mixture's specifications. In some embodiments, the sub-process 200 may begin with a step 201 by grinding and separating the mixture. As a result, the ground mixture is easier to be separated and filtered through when smaller than 0.3 mm and creating a more uniform mixture. The sub-process continues with a step 202 by presenting a gravity subprocess and a floatation subprocess. Based on the specifications of the mixture separation of the mixture may be better suited for gravity or floatation.

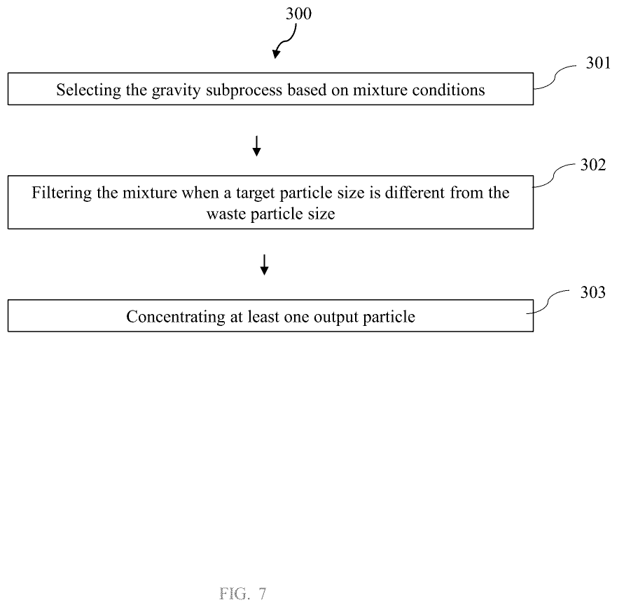

Filtering Target Particle Size (Sub-process 300, FIG. 7): Selects the gravity subprocess based on mixture conditions and uses a screening device to separate particles by size, then concentrates output particles using centrifugation. In some embodiments, the sub-process 300 may begin with a step 301 by selecting the gravity subprocess based on mixture conditions. The mixture conditions are based on a physical specificity, chemical specificity, biological specificity, and digital specificity. The sub-process continues with a step 302 by filtering the mixture when a target particle size is different from the waste particle size. Accordingly, if the particle sizes differ a screening device can be utilized to separate the two different sized particles with the threshold being smaller than the unwanted particle size and bigger than the wanted particle size or vise versa. The sub-process continues with a step 303 by concentrating at least one output particle. Centrifugation is a technique that separates particles from a mixture based on their size, shape, density, viscosity of the medium, and rotor speed. A centrifugal device is connected at an outlet port of a shaker device to produce concentrate from each outlet to further filter and separate the mixture. High speed centrifugal measured may be used to separate based on differences in density or weight.

The gravity screening equipment used in the present invention can be completely designed using physical methods, so there is no secondary pollution. Unlike most gravity screening tables on the market, which require the use of chemical assisted screening (which will generate secondary pollution sources).

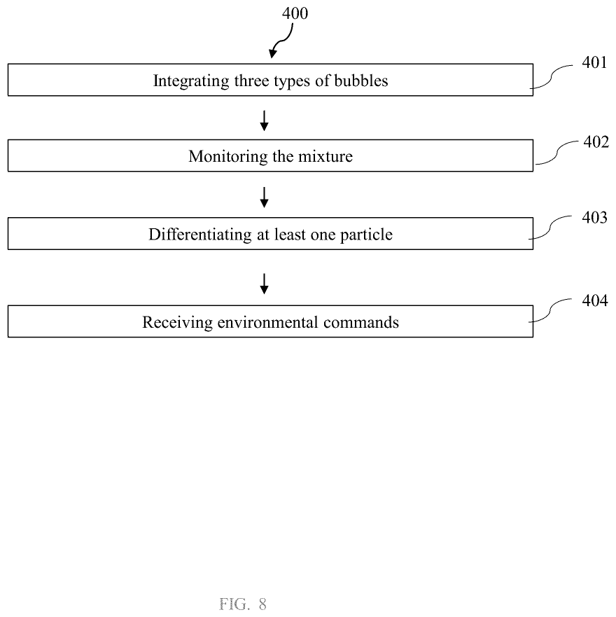

Utilizing Various Sized Bubbles for Filtration (Sub-process 400, FIG. 8): Integrates three types of bubbles (bubbles, micro bubbles, and nano bubbles) for flotation separation, monitored by a photographic observation system 1210 that differentiates particles using advanced technologies.

In some embodiments, the sub-process 400 may begin with a step 401 by integrating three types of bubbles. Consequently, three types of bubbles are added through the bubble generator 1231. The bubble generator 1231 can create bubbles, micro bubbles and nano bubbles. The bubble generator 1231 can be adjusted to adjust the bubble size and emission order to target specific particles within the mixture. The bubble generator 1231 is specifically designed for floatation separation that improved recovery rates and the efficiency of the removal of dyes. The bubble generator 1231 further can solve microbubbles in a liquid and use properties of a vortex pump turbine to effectively solve gas with a liquid or two liquids while adding it under pressure.

The sub-process continues with a step 402 by monitoring the mixture. The mixture is observed to ensure any changes in characteristics are noted. The sub-process continues with a step 403 by differentiating at least one particle. The sub-process continues with a step 404 by receiving environmental commands. Based off of any changes to the mixture observed by the photographic observation system 1210 an artificial intelligence system sends commands to automatically or semi-automatically control an environment. The photographic observation system 1210 includes an electron microscope 1211, camera 1213, and infrared device 1212. The photographic observation system 1210 differentiates particles using X-Ray and Near Infrared technologies.

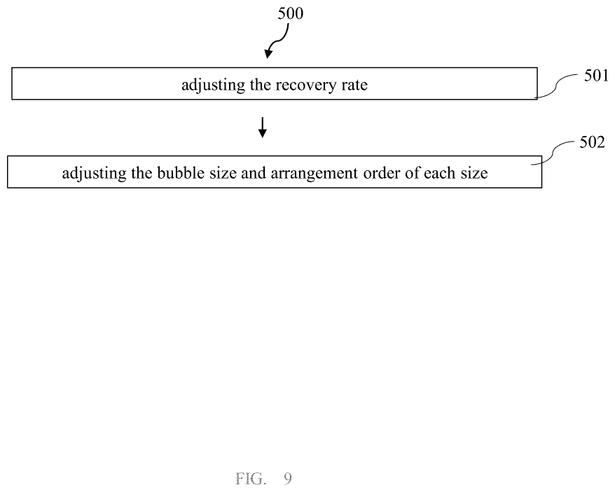

Adjusting the bubble generator (Sub-process 500, FIG. 9): Adjusts the recovery rate and bubble size to match target particles for flotation, altering bubble buoyancy. In some embodiments, the sub-process 500 may begin with a step 501 by adjusting the recovery rate. The bubble generator 1231 can be specifically designed for floatation separation which can then improve recovery rates. The bubble generator 1231 alters the buoyancy of the bubbles that affects the recovery rate. The sub-process continues with a step 502 by adjusting the bubble size and arrangement order of each size. The bubble generator 1231 alters the bubble size and emission order to match with the target particles for floatation.

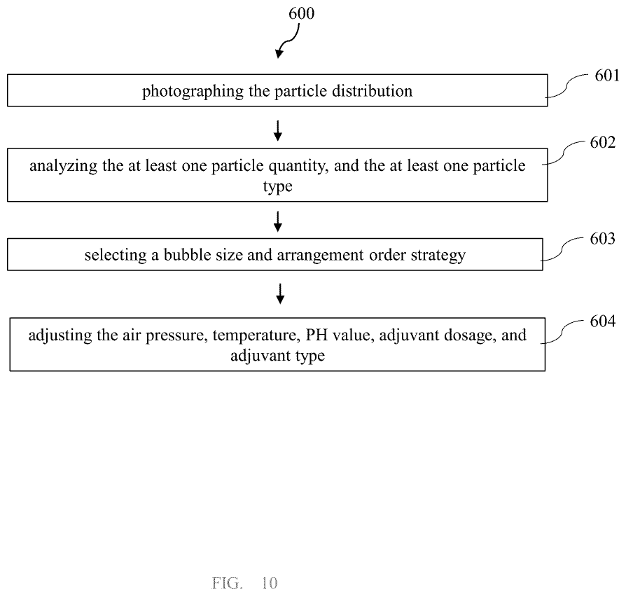

Monitoring Target Particle (Sub-process 600, FIG. 10): Involves photographing particle distribution, analyzing particle size, quantity, and type, and adjusting environmental conditions for optimal flotation. In some embodiments, the sub-process 600 may begin with a step 601 by photographing the particle distribution. As a result, the particles are able to be differentiated easier. The sub-process continues with a step 602 by analyzing the at least one particle size, the at least one particle quantity, and the at least one particle type. Accordingly, the type of particle can be determined creating criteria necessary for proper separation. The sub-process continues with a step 603 by selecting a bubble size and arrangement order strategy. The bubble size is then selected based on the target particle criteria and a bubble emission order is selected based on the target particle criteria. The sub-process continues with a step 604 by adjusting the air pressure, temperature, PH value, adjuvant dosage, and adjuvant type. Consequently, the environment is adjusted for what is most suitable for the target particle within the floatation device 1230.

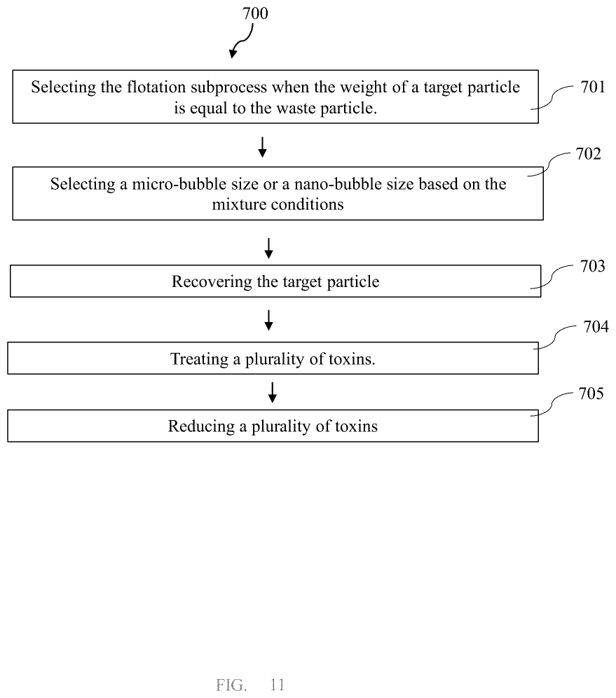

Particle Recovery Using Magnetization (Sub-process 700, FIG. 11): Selects flotation or magnetization based on particle weight similarity, utilizing micro or nano bubbles for filtration and reducing toxins with nano bubbles. In some embodiments, the sub-process 700 may begin with a step 701 by selecting the floatation subprocess when the weight of a target particle is equal to the waste particle. When the weight of two particles being compared is similar centrifugation may not be applicable and floatation separation may be used. The sub-process continues with a step 702 by selecting a micro-bubble size or a nano-bubble sized based on the mixture conditions. For example, for particularly fine particles, the floatation separation my use ultra-fine bubbles or micro bubbles to filter the particles out of the mixture. The sub-process continues with a step 703 by recovering the target particle. The recovery can be targeted to REE or heavy metals according to the specificity of components within the tailings or mixture. The sub-process continues with a step 704 by treating a plurality of toxins. The sub-process continues with a step 705 by reducing a plurality of toxins. The plurality of toxins can be treated and reduced utilizing nano-bubbles from the bubble generator 1231. The subprocess may utilize the ultra-fine bubble explosion principle to destroy the structure of at least one toxin contained in the incoming materials within the mixture. The at least toxins could be pesticides, chemical agent residues, and amongst other elements.

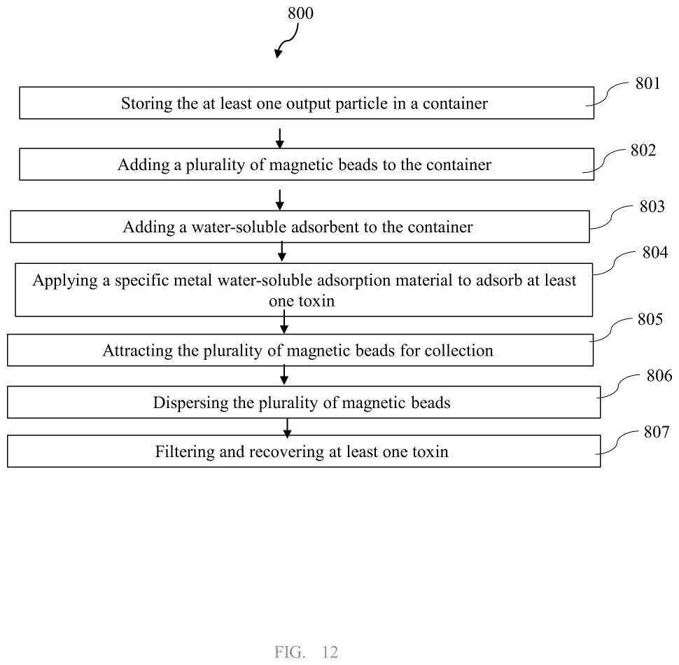

Removing Particles from Mixture (Sub-process 800, FIG. 12): Stores output particles, uses magnetic beads and water-soluble adsorbents for toxin adsorption, and recovers toxins using a magnetic field. In some embodiments, the sub-process 800 may begin with a step 801 by storing the at least one output particle in a container. The sub-process continues with a step 802 by adding a plurality of magnetic beads to the container. The plurality of magnetic beads is usually 20-30 nm for adsorption methods that include adsorbing target toxins. The sub-process continues with a step 803 by adding a water-soluble adsorbent to the container. The sub-process continues with a step 804 by applying a specific metal water-soluble adsorption material to adsorb at least one toxin. As a result, the target plurality of toxins is adsorbed within the container. The sub-process continues with a step 805 by attracting the plurality of magnetic beads for collection. The sub-process continues with a step 806 by dispersing the plurality of magnetic beads to filter and recover at least one toxin. So, the mixture is exposed to a magnetic field switch design that draws the plurality of magnetic beads to one side of the container. The plurality of magnetic beads is then dissolved with the plurality of adsorbed toxins within water and the remaining toxins are collected with a standard filter screen.

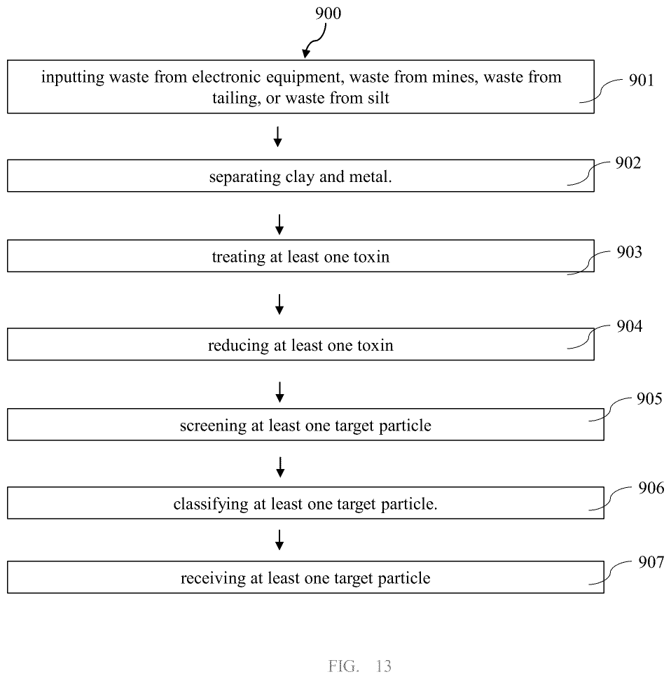

Filtering with a Gravitational Device (Sub-process 900, FIG. 13): Processes waste from various sources, separates clay and metal, treats and reduces toxins, and classifies target particles. In some embodiments, the sub-process 900 may begin with a step 901 by prompting inputting waste from electronic equipment, waste from mines, waste from tailing, or waste from silt. The waste may further include clay and various metals. The sub-process continues with a step 902 by separating clay and metal. The sub-process continues with a step 903 by treating at least one toxin. The sub-process continues with a step 904 by reducing at least one toxin. The plurality of toxins can be treated and reduced with similar methods previously disclosed utilizing the bubble generator 1231. The sub-process continues with a step 905 by screening at least one target particle. The sub-process continues with a step 906 by classifying at least one target particle. As a result, the target particle is categorized into a particle type. The sub-process continues with a step 907 by receiving at least one target particle.

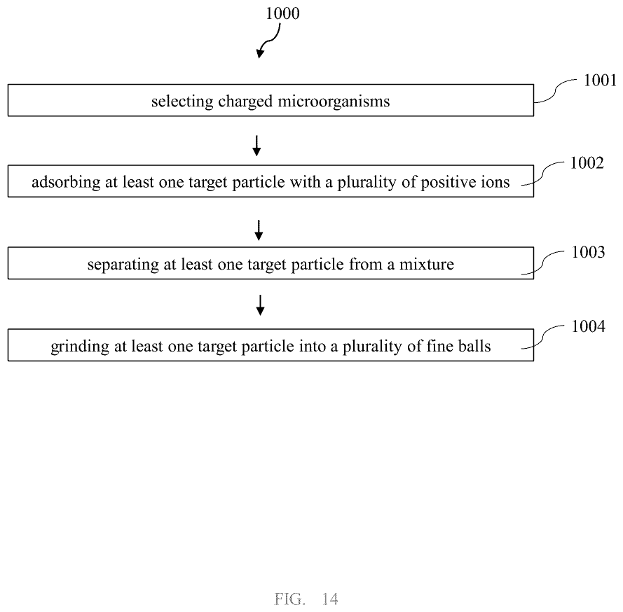

Filtration with a Biological Device (Sub-process 1000, FIG. 14): Uses charged microorganisms to separate clay from metals or REEs, adsorbs target particles with positive ions, and grinds them into fine balls. In some embodiments, the sub-process 1000 may begin with a step 1001 by selecting charged microorganisms. The biological device 1260 can further produce a specific plurality of microorganisms that is charged for efficient incubation, decomposing, and repelling the originally negatively charged clay on the surface. The sub-process continues with a step 1002 by adsorbing at least one target particle with a plurality of positive ions. As a result, the clay is separated from the specific metal or REE. The sub-process continues with a step 1003 by separating at least one target particle from a mixture. The sub-process continues with a step 1004 by grinding at least one target particle into a plurality of fine balls. As required the physical and mechanical methods are combined to create a finely ground uniform target particle.

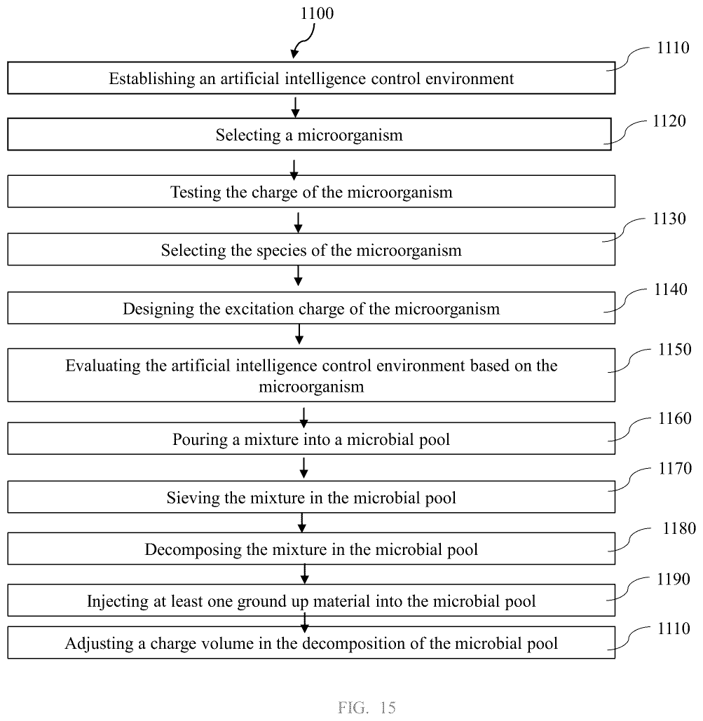

Biological Filtration with Artificial Intelligence (Sub-process 1100, FIG. 15): Utilizes AI to select and test charged microorganisms for efficient separation of clay and REEs, adjusting charge volume in microbial pools for sieving and decomposition. In some embodiments, the sub-process 1100 may begin with a step 1101 by establishing an artificial intelligence control environment which can be a procedure of employing one or more AI modules. The sub-process continues with a step 1102 by selecting a microorganism. The biological device 1260 is used to separate clay and REE with a microorganism that is charged for efficient incubation, decomposing, and repelling the originally negatively charged clay on the surface. The sub-process continues with a step 1103 by testing the charge of the microorganism. For example, general soil or clay often has a negative charge on the surface, and electrostatically charged cations (e.g., manganese, potassium, calcium, sodium, etc.) are attracted to the surface of the clay particles. Clay has the characteristics of strong tension in contact with water unless the water causes expansion, and the tight tension is reduced (like balloon inflation to rupture). The sub-process continues with a step 1104 selecting the species of the microorganism. The sub-process continues with a step 1105 designing the excitation charge of the microorganism. The clay and REE separation may include excitation where the charge volume is adjusted in the microbial pool. The sub-process continues with a step 1106 by evaluating the artificial intelligence control environment based on the microorganism. The sub-process continues with a step 1107 by pouring a mixture into a microbial pool. The microbial pool is utilized for sieving and decomposition for particle of different sizes and may comprise a plurality of discharge ports. The sub-process continues with a step 1008 by sieving the mixture in the microbial pool. The sub-process continues with a step 1109 by decomposing the mixture in the microbial pool. The sub-process continues with a step 1110 by injecting at least one ground up material into the microbial pool. The sub-process continues with a step 1111 by adjusting a charge volume in the decomposition of the microbial pool. In some embodiments, the microbial pool can be a collection or community of microorganisms and may include a container designed to contain collection or community of microorganisms present in a flotation system.

Flotation involves adding specific additives to a system to collect target elements with bubbles, along with destroying harmful toxins. It serves two purposes: removing toxins and collecting specific elements. Evaluation of material ingredients helps determine the order of processes like flotation, magnetic separation, and gravity screening. Grinding is crucial for achieving target specifications regardless of the filtration method used.

Each sub-process employs specific techniques and technologies to enhance the efficiency of particle recovery and toxin reduction, aiming for a more environmentally friendly approach to material recovery.

The method 100 may firstly include steps of screening and classifying tiny particles constituted in the mixture based on magnetic separation 1260; screening and classifying tiny particles constituted in the mixture based on gravity separation 1270. The method 100 may encompass distinct steps 1200 to address pollutants or toxins using a bubble generator, in addition to the previously mentioned sub-processes.

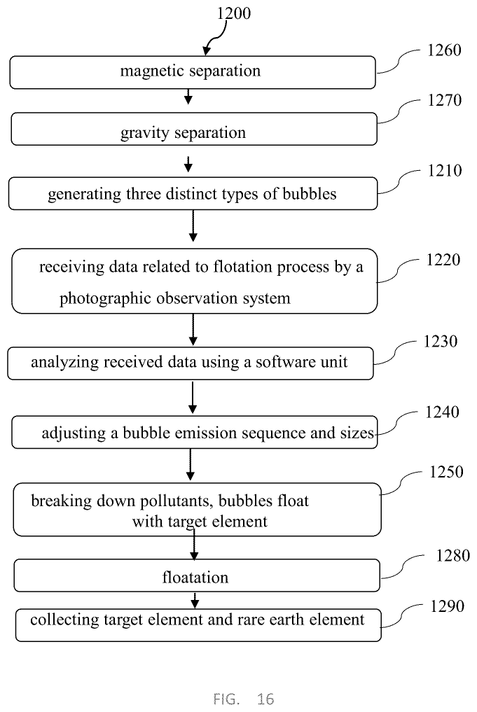

In one embodiment, such steps may include: receiving a mixture 101; separating clay and metal constituted in the mixture 102; treating pollutants or toxins constituted in the mixture with magnetic beads 103; treating the pollutants or toxins by a bubble generator 104, wherein, as shown in FIG. 16, treating the pollutants or toxins includes steps of: generating three distinct types of bubbles: bubbles 1210, microbubbles, and nanobubbles, wherein the nanobubbles have a diameter of less than 1 nm, and the microbubbles have a diameter ranging from 1 μm to 1 mm, receiving data related to flotation process by a photographic observation system 1220, analyzing received data using a software unit 1250 at 1230, adjusting a bubble emission sequence and sizes based on analyzing the received data 1240, breaking down pollutants 1250 and floating the target element; screening and classifying tiny particles constituted in the mixture based on floatation 1280; and collecting at least one target element and rare earth element 1290.

In such embodiments, the method 100 may further comprise one or more of the sub-processes (200 to 1100).

Although the invention has been explained in relation to its preferred embodiment, it is to be understood that many other possible modifications and variations can be made without departing from the spirit and scope of the invention as hereinafter claimed.

What is claimed is:

1. A system comprising:
a software unit;
a photographic observation system; and
a bubble generator, the bubble generator includes a Bubble generator, a Micro-Bubble generator, a Nano-Bubbles generator;
wherein each of the software unit, the photographic observation system, the bubble generator are interconnected with one another.

2. The system as claimed 1, wherein:
the photographic observation system includes an electron microscope, a camera, and an infrared device.

3. The system as claimed 1, wherein:
the gravitational device includes a shaker table, a sieve device, and a centrifugal device.

4. The system as claimed 1, further comprising a gravitational device; a grinding system; a magnetic field device and a biological device,
wherein the grinding system includes an anti-leakage net,
wherein each of the software unit, the photographic observation system, the bubble generator, the gravitational device, the grinding system, the magnetic field device, and the biological device are interconnected with one another.

5. A method comprising steps of:
receiving a mixture;
separating clay and metal constituted in the mixture;
treating pollutants or toxins constituted in the mixture with magnetic beads;
treating the pollutants or toxins by a bubble generator, wherein treating the pollutants or toxins includes steps of:
generating three distinct types of bubbles: bubbles, microbubbles, and nanobubbles, wherein the nanobubbles have a diameter of less than 1 nm, and the microbubbles have a diameter ranging from 1 μm to 1 mm,
receiving data related to flotation process by a photographic observation system,
analyzing received data using a software unit,
adjusting a bubble emission sequence and sizes based on analyzing the received data,
breaking down pollutants; and
floating target elements;
screening and classifying tiny particles constituted in the mixture based on magnetic separation;
screening and classifying tiny particles constituted in the mixture based on gravity separation;
screening and classifying tiny particles constituted in the mixture based on floatation used with the bubble generator; and
collecting at least one target element and rare earth element.

6. The method as claimed in claim 5 comprising:
grinding and separating, by using a grinding system, the mixture; and
presenting, by using a software unit, a gravity subprocess and a floatation subprocess.

7. The method as claimed in claim 6 comprising:
selecting, by using the software unit, the gravity subprocess;
filtering, by using a sieve device, the mixture when a target particle size is different from a waste particle size; and
concentrating, with a centrifugal device, at least one output particle.

8. The method as claimed in claim 7 comprising:
integrating, by using a bubble generator, two or more types of bubbles of the three distinct types of bubbles;
monitoring, by using a photographic observation system, the mixture; and
differentiating, by using the photographic observation system, at least one particle from the mixture.

9. The method as claimed in claim 8 comprising:
adjusting, by using the software unit, a recovery rate.

10. The method as claimed in claim 9 comprising:
photographing, by using the photographic observation system, a particle distribution;
analyzing, by using the software unit, the at least one particle size, the at least one particle quantity, and the at least one particle type; and
adjusting, by using the software unit, the air pressure, temperature, PH value, adjuvant dosage, and adjuvant type.

11. The method as claimed in claim 10 comprising:
storing the at least one output particle in a container;
adding a plurality of magnetic beads to the container;
adding a water-soluble adsorbent to the container;
applying a specific metal water-soluble adsorption material to adsorb at least one toxin;
attracting, by using a magnetic field device, the plurality of magnetic beads for collection; and
dispersing, using the sieve device, the plurality of magnetic beads to filter and recover at least one toxin.

12. The method as claimed in claim 11 comprising:
inputting, by using a gravitational device, waste;
separating, by using the gravitational device, clay and metal;
treating, by using the gravitational device, at least one toxin;
reducing, by using the gravitational device, at least one toxin;
screening, by using the gravitational device, at least one target particle;
classifying, by using the gravitational device, at least one target particle; and
receiving, by using the gravitational device, at least one target particle.

13. The method as claimed in claim 12 comprising:
selecting, by using the software unit, charged microorganisms;
adsorbing, by using the biological device, at least one target particle with a plurality of positive ions;
separating, using the biological device, at least one target particle from a mixture; and
grinding, using the grinding system, at least one target particle into a plurality of fine balls.

14. The method as claimed in claim 13 comprising:
selecting, by using the software unit, a microorganism, wherein the software unit includes an artificial intelligence module;
testing, by using the biological device, a charge of the microorganism;
selecting, by using the biological device, species of the microorganism;
designing, by using the biological device, an excitation charge of the microorganism;
pouring, by using the biological device, a mixture into a microbial pool;
sieving, by using the biological device, the mixture in the microbial pool;
decomposing, by using the biological device, the mixture in the microbial pool;
injecting, by using the biological device, at least one ground up material into the microbial pool; and
adjusting, by using the biological device, a charge volume in decomposition of the microbial pool.

15. A method comprising the steps of:
receiving a mixture;
separating clay and metal constituted in the mixture;
treating pollutants or toxins constituted in the mixture with magnetic beads;
treating the pollutants or toxins by a bubble generator, wherein treating the pollutants or toxins includes steps of:
generating three distinct types of bubbles: bubbles, microbubbles, and nanobubbles,
receiving data related to flotation process by a plurality of sensors and camera connected to a computing device,
analyzing received data using a software unit,
adjusting a bubble emission sequence and sizes based on analyzing the received data,
breaking down pollutants, and
floating target elements;
screening and classifying tiny particles constituted in the mixture based on magnetic separation;
screening and classifying tiny particles constituted in the mixture based on gravity separation;
screening and classifying tiny particles constituted in the mixture based on floatation; and
collecting at least one target element and rare earth element.

16. The method as claimed in claim 15 comprising:
grinding and separating, by using a grinding system, the mixture; and
presenting, by using a software unit, a gravity subprocess and a floatation subprocess.

17. The method as claimed in claim 16 comprising:
selecting, by using the software unit, the gravity subprocess;
filtering, by using a sieve device, the mixture when a target particle size is different from a waste particle size; and
concentrating, with a centrifugal device, at least one output particle.

18. The method as claimed in claim 17 comprising:
integrating, by using a bubble generator, two or more types of bubbles of the three distinct types of bubbles;
monitoring, by using a photographic observation system, the mixture; and
differentiating, by using the photographic observation system, at least one particle from the mixture.

19. The method as claimed in claim 18 comprising:
adjusting, by using the software unit, a recovery rate.

20. The method as claimed in claim 19 comprising:
photographing, by using the photographic observation system, a particle distribution;
analyzing, by using the software unit, the at least one particle size, the at least one particle quantity, and the at least one particle type; and
adjusting, by using the software unit, the air pressure, temperature, PH value, adjuvant dosage, and adjuvant type.
